(19) United States
(12) Patent Application Publication
(10) Pub. No.: US 2018/0043631 A1
(43) Pub. Date: Feb. 15, 2018

(54) ADAPTIVE LAYER HEIGHT

(71) Applicant: Stratasys, Inc., Eden Prairie, MN (US)

(72) Inventors: Erik K. Heide, Eden Prairie, MN (US); Thomas J. Studanski, Plymouth, MN (US)

(21) Appl. No.: 15/235,603

(22) Filed: Aug. 12, 2016

(51) Int. Cl. B29C 67/00; B33Y 50/00; B33Y 10/00

(52) U.S. Cl. CPC B29C 67/0077; B33Y 10/00; B33Y 50/00; B29C 67/0088

(57) ABSTRACT

A method of additive manufacturing prints a part by adding layers to the part. The heights of the layers are determined by determining an orientation of at least one surface of a model of the part and setting a layer height for a layer to be added to the part based on the determined orientation of the at least one surface of the model of the part.

### BACKGROUND

The present disclosure relates to additive manufacturing methods for printing three-dimensional (3D) parts. Additive manufacturing is generally a process in which a three-dimensional (3D) object is manufactured utilizing a computer model of the objects. The basic operation of an additive manufacturing system consists of slicing a three-dimensional computer model into thin cross sections, translating the result into two-dimensional position data, and feeding the data to control equipment which manufacture a three-dimensional structure in a layerwise manner using one or more additive manufacturing techniques. Additive manufacturing entails many different approaches to the method of fabrication, including fused deposition modeling, ink jetting, selective laser sintering, powder/binder jetting, electron-beam melting, electrophotographic imaging, and stereolithographic processes.

In extrusion-based additive manufacturing systems (also referred to as fused deposition modeling), an extruder on a print head extrudes a bead of material as the print head is moved along a tool path to form a single layer of a part. The bead of material has a height, referred to as a layer height, and a width, referred to as a road width. After depositing a layer of material, either the part is lowered or the print head is raised by an amount equal to the layer height, and the next layer of the part is extruded. Typically, both part and support materials are deposited in a like manner, such that a support structure is built underneath overhanging portions, in cavities, or otherwise supporting a part under construction. A host computer generates additional geometry acting as a support structure for the overhanging or free-space segments of the 3D part being formed. The layerwise deposition process is repeated to form a printed part resembling the digital representation.

In an electrophotographic 3D printing process, each slice of the digital representation of the 3D part and its support structure is printed or developed using an electrophotographic engine. The electrophotographic engine generally operates in accordance with 2D electrophotographic printing processes, but with a polymeric toner. The electrophotographic engine typically uses a conductive support drum that is coated with a photoconductive material layer, where latent electrostatic images are formed by electrostatic charging, followed by image-wise exposure of the photoconductive layer by an optical source. The latent electrostatic images are then moved to a developing station where the polymeric toner is applied to charged areas, or alternatively to discharged areas of the photoconductive insulator to form the layer of the polymeric toner representing a slice of the 3D part. The developed layer is transferred to a transfer medium, from which the layer is transfused to previously printed layers with heat and/or pressure to build the 3D part.

There are two competing goals when setting the layer height for an additive manufacturing system. The first is that the part should be manufactured as quickly as possible. This goal leads to the selection of the tallest possible layer height since taller layer heights require fewer total layers and thus fewer printing steps to produce the part. The second goal is to form a part with smooth surfaces that accurately reflect the model of the part being constructed. This goal leads to the selection of the shortest possible layer heights, since shorter layer heights reduce the stair-step appearance of some surfaces and allow the part to be constructed such that the part's dimensions are close to the model's dimensions. As the layer heights increase, the differences between the part's dimensions and the model's dimensions tend to increase and some surfaces on the part start to look jagged.

### SUMMARY

A method of additive manufacturing prints a part by adding layers to the part. The heights of the layers are determined by determining an orientation of at least one surface of a model of the part and setting a layer height for a layer to be added to the part based on the determined orientation of the at least one surface of the model of the part.

In a further embodiment, an additive manufacturing system includes a processor that receives a model of a part and designates different layer heights for different portions of the part based in part on orientations of surfaces of the model. The AM system prints layers of material at thicknesses based on the layer heights designated by the processor.

In a still further embodiment, an additive manufacturing system includes a processor that receives a model of a part and slices the part to form tool paths with layer heights wherein different tool paths have different layer heights based in part on orientations of surfaces of the model.

### BRIEF DESCRIPTION OF THE DRAWINGS

FIG. 1 is a block diagram of an additive manufacturing system in accordance with one embodiment.

FIG. 2 is a flow diagram of a method of slicing a model to produces tool paths having differing layer heights.

FIG. 3 is a flow diagram of a method of initializing layer height parameters used in the method of FIG. 2.

FIG. 4 is a side view of deposited layers of material showing layers of differing heights.

FIG. 5 is a flow diagram of a method of identifying a best layer height for a portion of a model in accordance with one embodiment.

FIG. 6 is a side view of a graphical representation of a model in accordance with one embodiment.

FIG. 7 is a side view of two columns of deposited material showing a change in the total height of the columns by changing the height of a layer of deposited material.

FIG. 8 is a side view of two columns of deposited material showing a change in the total height of the columns by changing the height of a layer of deposited material.

FIG. 9 shows a side view of a part formed through the process of FIG. 2.

FIG. 10 is a block diagram of a computing device that can be used with the various embodiments.

### DETAILED DESCRIPTION OF ILLUSTRATIVE EMBODIMENTS

In the embodiments described below, parts are manufactured using a set of different layer heights. Before manufacturing the part, a model of the part is sliced to identify a best layer height for different portions of the model. The best layer height for a slice is selected based on how close to vertical the surfaces of the model are that intersect the slice. As noted above, it is better to have shorter layer heights for surfaces that are close to horizontal so as to reduce the stair-step or jagged appearance of the surface and it is better to have taller layer heights for vertical surfaces so as to reduce the print time. In some embodiments, to avoid having a large number of changes in the layer height, the best layer height is determined for multiple contiguous slices to form bands of slices that are assigned the same layer height. In still further embodiments, limits are applied that control how much the layer height can change between successive slices. In additional embodiments, the layer heights of one or more slices are altered to reduce the difference between the height of a key point on the part and the height of the same key point on the model.

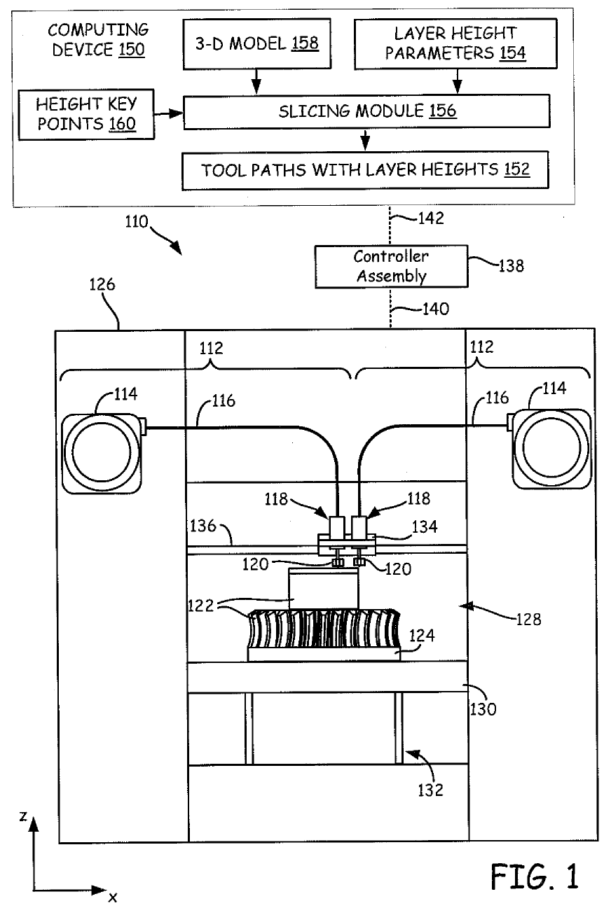

Embodiments of the present disclosure may be used with any suitable additive manufacturing system. FIG. 1 shows one such system 110 that is an extrusion-based additive manufacturing system for printing 3D parts or models and corresponding support structures (e.g., 3D part 122 and support structure 124) from part and support material filaments, respectively, of consumable assemblies 112, using a layer-based, additive manufacturing technique. Suitable additive manufacturing systems for system 110 include extrusion-based systems developed by Stratasys, Inc., Eden Prairie, Minn., such as fused deposition modeling systems under the trademark “FDM”.

In FIG. 1, there are two consumable assemblies 112, where one of the consumable assemblies 112 contains a part material filament, and the other consumable assembly 112 contains a support material filament. However, both consumable assemblies 112 may contain part material filaments in some embodiments. Each consumable assembly 112 is an easily loadable, removable, and replaceable container device that retains a supply of a consumable filament for printing.

In the shown embodiment, each consumable assembly 112 includes container portion 114, guide tube 116, and print heads 118, where each print head 118 preferably includes an extruder 120 of the present disclosure. Container portion 114 may retain a spool, coil, or other supply arrangement of a consumable filament, such as discussed in Mannella et al., U.S. Pat. Nos. 28,985,497 and 9,073,263; and in Batchelder et al., U.S. Pat. No. 9,090,428.

Guide tube 116 interconnects container portion 114 and print head 118, where a drive mechanism of print head 118 (and/or of system 110) draws successive segments of the consumable filament from container portion 114, through guide tube 116, to the extruder 120 of the print head 118. In this embodiment, guide tube 116 and print head 118 are subcomponents of consumable assembly 112, and may be interchanged to and from system 110 with each consumable assembly 112. Alternatively, as discussed below, guide tube 116 and/or print head 118 (or parts thereof) may be components of system 110, rather than subcomponents of consumable assemblies 112.

As shown, system 110 includes system housing 126, chamber 128, platen 130, platen gantry 132, head carriage 134, and head gantry 136. System housing 126 is a structural component of system 110 and may include multiple structural sub-components such as support frames, housing walls, and the like. In some embodiments, system housing 126 may include container bays configured to receive container portions 114 of consumable assemblies 112. In alternative embodiments, the container bays may be omitted to reduce the overall footprint of system 110. In these embodiments, container portions 114 may stand adjacent to system housing 126, while providing sufficient ranges of movement for guide tubes 116 and print heads 118.

Chamber 128 is an enclosed environment that contains platen 130 for printing 3D part 122 and support structure 124. Chamber 128 may be heated (e.g., with circulating heated air) to reduce the rate at which the part and support materials solidify after being extruded and deposited (e.g., to reduce distortions and curling). In alternative embodiments, chamber 128 may be omitted and/or replaced with different types of build environments. For example, 3D part 122 and support structure 124 may be built in a build environment that is open to ambient conditions or may be enclosed with alternative structures (e.g., flexible curtains).

Platen 130 is a platform on which 3D part 122 and support structure 124 are printed in a layer-by-layer manner, and is supported by platen gantry 132. In some embodiments, platen 130 may engage and support a build substrate, which may be a tray substrate as disclosed in Dunn et al., U.S. Pat. No. 7,127,309, fabricated from plastic, corrugated cardboard, or other suitable material, and may also include a flexible polymeric film or liner, painter's tape, polyimide tape (e.g., under the trademark KAPTON from E.I. du Pont de Nemours and Company, Wilmington, Del.), or other disposable fabrication for adhering deposited material onto the platen 130 or onto the build substrate. Platen gantry 132 is a gantry assembly configured to move platen 130 along (or substantially along) the vertical z-axis.

Head carriage 134 is a unit configured to receive one or more removable print heads, such as print heads 118, and is supported by head gantry 136. Examples of suitable devices for head carriage 134, and techniques for retaining print heads 118 in head carriage 134, include those disclosed in Swanson et al., U.S. Pat. Nos. 8,403,658 and 8,647,102. In some preferred embodiments, each print head 118 is configured to engage with head carriage 134 to securely retain the print head 118 in a manner that prevents or restricts movement of the print head 118 relative to head carriage 134 in the x-y build plane, but allows the print head 118 to be controllably moved out of the x-y build plane (e.g., servoed, toggled, or otherwise switched in a linear or pivoting manner).

Head gantry 136 is a belt-driven gantry assembly configured to move head carriage 134 (and the retained print heads 118) in (or substantially in) a horizontal x-y plane above chamber 128. Examples of suitable gantry assemblies for head gantry 136 include those disclosed in Comb et al., U.S. Pat. No. 9,108,360, where head gantry 136 may also support deformable baffles (not shown) that define a ceiling for chamber 128. In alternative embodiments, head gantry 136 may utilize any suitable mechanism for moving head carriage 134 (and the retained print heads 118), such as robotic actuators, and the like.

In a further alternative embodiment, platen 130 may be configured to move in the horizontal x-y plane within chamber 128, and head carriage 134 (and print heads 118) may be configured to move along the z-axis. Other similar arrangements may also be used such that one or both of platen 130 and print heads 118 are moveable relative to each other. Platen 130 and head carriage 134 (and print heads 118) may also be oriented along different axes. For example, platen 130 may be oriented vertically and print heads 118 may print 3D part 122 and support structure 124 along the x-axis or the y-axis. In another example, platen 130 and/or head carriage 134 (and print heads 118) may be moved relative to each other in a non-Cartesian coordinate system, such as in a polar coordinate system.

Additional examples of suitable devices for print heads 118, and the connections between print heads 118, head carriage 134, and head gantry 136 include those disclosed in Crump et al., U.S. Pat. No. 5,503,785; Swanson et al., U.S. Pat. No. 6,004,124; LaBossiere, et al., U.S. Pat. Nos. 7,384,255 and 7,604,470; Batchelder et al., U.S. Pat. Nos. 7,896,209 and 7,897,074; and Comb et al., U.S. Pat. No. 8,153,182. For instance, extruder 120 may optionally be retrofitted into an existing additive manufacturing system.

System 110 also includes controller assembly 138, which is one or more computer-based systems configured to operate the components of system 110. Controller assembly 138 may communicate over communication line(s) 140 with the various components of system 110, such as print heads 118 (including extruder 120), chamber 128 (e.g., with a heating unit for chamber 128), head carriage 134, motors for platen gantry 132 and head gantry 136, and various sensors, calibration devices, display devices, and/or user input devices.

Additionally, controller assembly 138 may also communicate over communication line 142 with external devices, such as computing device 150 over a network connection (e.g., a local area network (LAN) connection, a universal serial bus (USB) connection, or the like). While communication lines 140 and 142 are each illustrated as a single signal line, they may each include one or more electrical, optical, and/or wireless signal lines and intermediate control circuits, where portions of communication line(s) 140 may also be subcomponents of the removable print heads 118.

In some embodiments, computing device 150 and controller assembly 138 are internal to system 110, allowing a user to operate system 110 over a network communication line 142, in the same or similar manner as a two-dimensional printer. Alternatively, computing device 150 may be one or more external computer-based systems (e.g., desktop, laptop, server-based, cloud-based, tablet, mobile media device, and the like) that may communicate with the internal computer-based system(s) of controller assembly 138.

In accordance with one embodiment, computing device 150 provides a set of tool paths with layer heights 152 to controller assembly 138. During a printing operation, controller assembly 138 may direct platen gantry 132 to move platen 130 to a predetermined height within chamber 128 based on the height of the next layer in tool paths 152. Controller assembly 138 may then direct head gantry 136 to move head carriage 134 (and the retained print heads 118) around in the horizontal x-y plane above chamber 128 along the tool path 152 for the layer. Controller assembly 138 may also command print heads 118 to selectively draw successive segments of the consumable filaments from container portions 114 and through guide tubes 116, respectively.

The successive segments of each consumable filament are then melted in the extruder 120 of the respective print head 118 to produce a molten material. Upon exiting extruder 120, the resulting extrudate may be deposited onto platen 130 as a series of roads for printing 3D part 122 or support structure 124 in a layer-by-layer manner. After the print operation is complete, the resulting 3D part 122 and support structure 124 may be removed from chamber 128, and support structure 124 may be removed from 3D part 122. 3D part 122 may then undergo one or more additional post-processing steps, as desired.

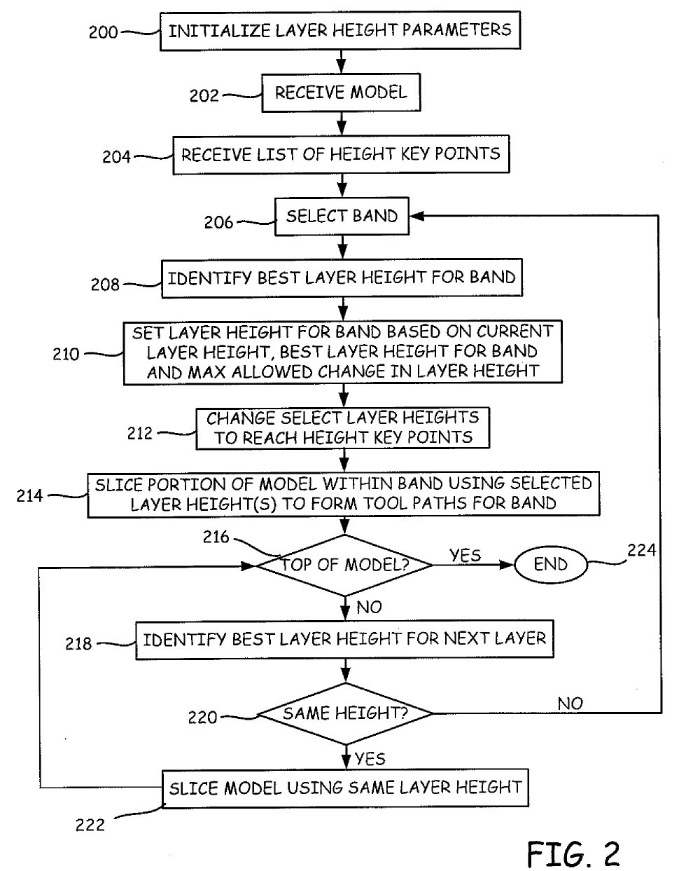

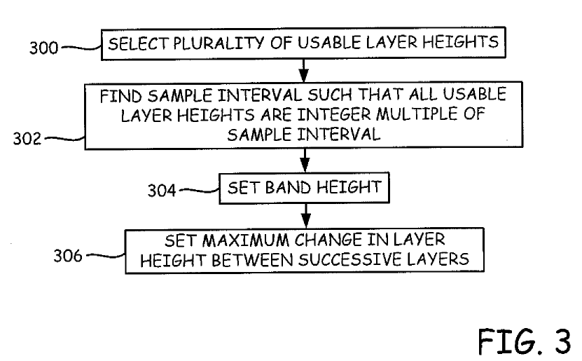

FIG. 2 provides a flow diagram of a method used by a slicing module 156 to identify the layer heights of each layer in tool paths with layer heights 152. At step 200 of the method, layer height parameters 154 of FIG. 1 are initialized. Layer height parameters 154 define parameters used in determining what layer heights to apply to different portions of a 3-D model 158. FIG. 3 provides a flow diagram of a method for performing step 200.

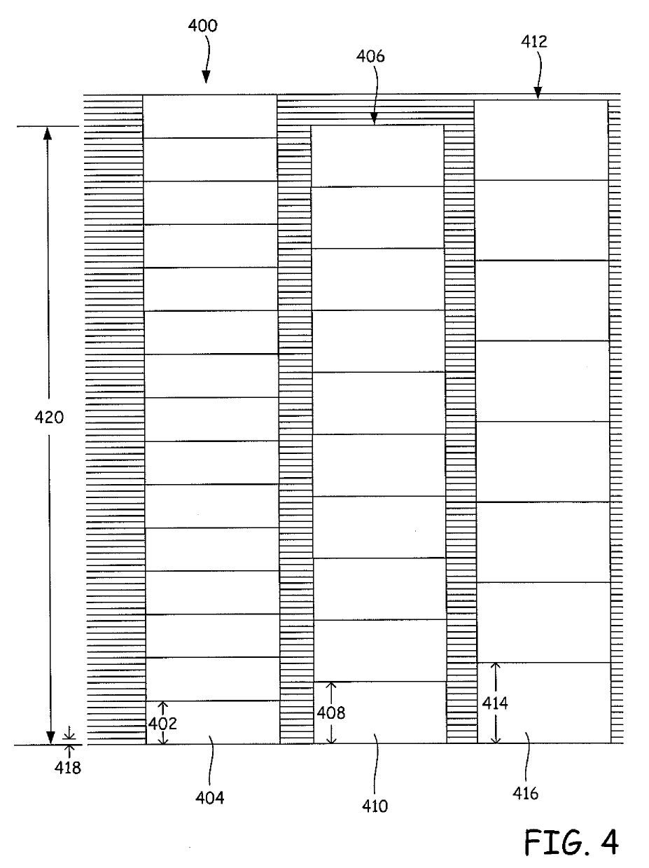

In step 300 of FIG. 3, a plurality of usable layer heights is selected. A usable layer height is a layer height that may be used in printing a layer of a part. FIG. 4 provides examples of three different usable layer heights 402, 408 and 414 that can be selected at step 300. In FIG. 4, a side view of three columns of material is shown where each column is formed of multiple extruded layers having the three respective exemplary layer heights. Column 400 is formed from fifteen layers, such as layer 404, that each has layer height 402. Column 406 is formed from ten layers, such as layer 410, that each has layer height 408. Column 412 is formed from eight layers, such as layer 416, that each has layer height 414. Layer height 402 is shorter than layer height 408, which is shorter than layer height 414. In accordance with one embodiment, layer heights 402, 408 and 414 are 0.007 inch, 0.010 inch, and 0.013 inch, respectively, however, other embodiments are not limited to any of these specific layer heights.

At step 302, a sampling interval or height is selected. The sampling interval is a vertical interval between horizontal sampling planes that are used to sample surfaces of the model to determine a best layer height for the surfaces. Such sampling is discussed further below. In step 302, the sampling interval is selected such that each of the selected usable layer heights is an integer multiple of the sampling interval. For example, in FIG. 4, an exemplary sampling interval 418 is shown for layer heights 402, 408 and 414. As shown, each of layer heights 402, 408 and 414 is an integer multiple of sampling interval 418. For instance, for the embodiment where layer heights 402, 408 and 414 are 0.007 inch, 0.010 inch, and 0.013 inch, respectively, sampling interval 418 is 0.001 inch meaning that layer height 402 is seven times sampling interval 418, layer height 408 is ten times sampling interval 418 and layer height 414 is thirteen times sampling interval 418.

At step 304, a band height is set such as band height 420 of FIG. 4. The band height is a minimum height across which the layer height should not change. The band height is selected to minimize disruptions in the appearance of the part caused by multiple changes in the layer height. The band height is an integer multiple of the sampling interval.

At step 306, a maximum change in layer height between layers is set. For example, the maximum layer height can be set to 0.003 inch, meaning that the layer height could change from 0.007 inch to 0.010 inch between successive layers but could not change from 0.007 inch to 0.013 inch or from 0.013 inch to 0.007 inch between successive layers.

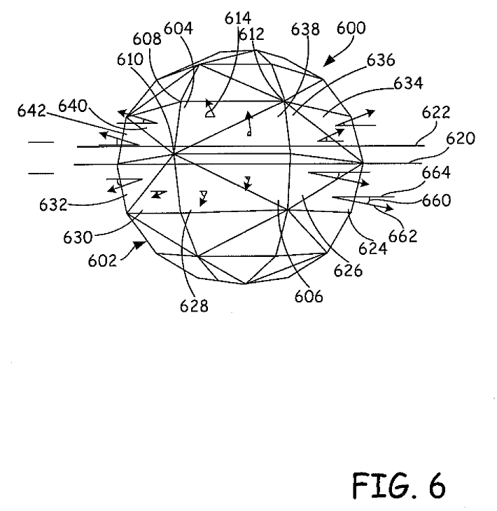

Returning to the method of FIG. 2, after layer height parameters 154 have been set at step 200, 3-D model 158 is received at step 202. FIG. 6 provides a graphical depiction of an exemplary 3-D model 600, which shows that the model is constructed of a polygon mesh 602 formed by joined polygons, such as polygons 604 and 606, that are positioned in three-dimensional space. Each polygon is defined by the three-dimensional coordinates of its vertices, such as vertices 608, 610 and 612 of polygon 604, and an outwardly facing normal of the polygon, such as normal 614 of polygon 604.

At step 204, a list of height key points 160 is received. Because extrusion-based additive manufacturing systems build parts from discrete layers, it can be difficult to build the parts to the exact dimensions found in the model. For example, the overall height of the built part may be different from the overall height of the model because the top of the model falls in the middle of a layer rather than at the top of a layer. As a result, the built part will either be slightly larger than the model or slightly smaller than the model. The height key points in list 160 are points in the model that the designer wants the built part to match as much as possible. Thus, the part designer wants the part to be built such that the heights of the key points on the part are as close to the heights of those points on the model as possible. For example, the top of the model can be in the list of key points such that the overall height of the built part is as close as possible to the overall height of the model. By building the part so that the built key points are as close as possible to the model key points, it is possible to construct a “near net” part, which is a part that requires very little post-print processing to achieve the desired size and shape for the part.

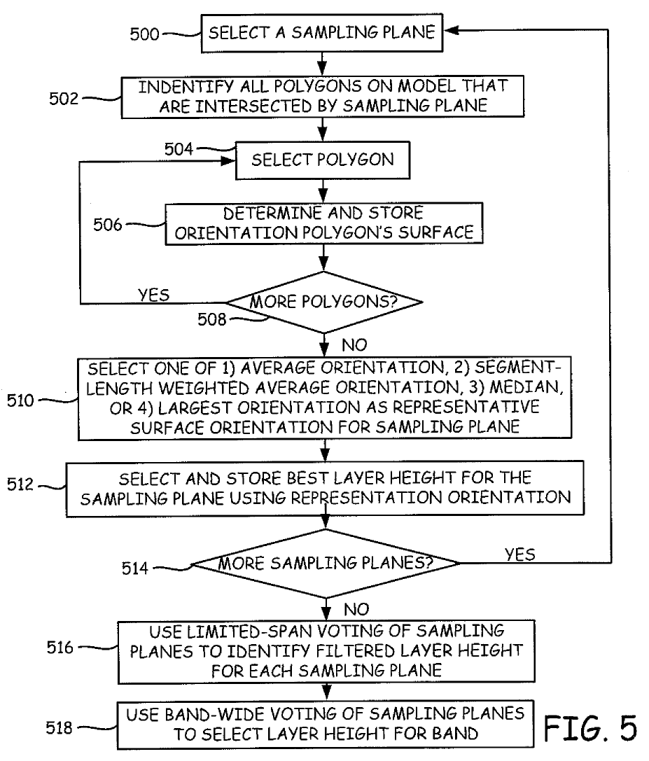

At step 206, a band of 3-D model 158 is selected. In most embodiments, the first band that is selected begins at the bottom of 3-D model 158 and extends upward by the band height amount set at step 200 and stored in layer height parameters 154. The process then continues at step 208 where a best layer height for the band is determined based on the polygons of the 3-D model that are within the band. FIG. 5 provides a flow diagram of a method of identifying the best layer heights for a band based on the polygons of the 3-D model.

In step 500, a bottommost sampling plane in the band is selected and at step 502, all polygons on the model that are intersected by the sampling plane are identified. For example, in FIG. 6, two sampling planes 620 and 622 are shown. Sampling plane 620 is shown to intersect polygons 606, 624, 626, 628, 630 and 632 and sampling plane 622 is shown to intersect polygons 604, 634, 636, 638, 640 and 642.

At step 504, one of the polygons intersected by the selected sampling plane is selected and at step 506 the orientation of the surface of the polygon is determined. In one particular embodiment, the orientation is determined by determining an angle between the polygon's outwardly facing normal and a horizontal component of that normal. For example, if polygon 624 is selected at step 504, angle 660 between normal 662 and the horizontal component 664 of normal 662 is determined at step 506. At step 508, the method determines if more polygons intersected by the selected sampling plane need to be processed. If so, the method returns to step 504 to select a new polygon intersected by the sampling plane selected at step 500 and step 506 is repeated for the new polygon.

When an orientation has been determined for each of the polygons intersected by the selected sampling plane at step 508, the process continues at step 510 where a representative orientation is determined from those orientations. In the various embodiments, the representative orientation can be any one of an average of all of the orientations, a segment length-weighted average orientation; a median of all of the orientations, and a largest or smallest orientation, for example. The segment-length weighted orientation weights each orientation by the relative length of the segment formed by the intersection of the sampling plane with the polygon, where the length is relative to total length of all segments formed by the intersection of the sampling plane with the model.

At step 512, a best layer height for the selected sampling plane is determined using the representative orientation. In some embodiments, each of the usable layer heights is associated with a range of representative orientations. For example, a smallest layer height can be assigned to representative orientations where the angle between the normal and the horizontal component of the normal is between 90° and 78°, an intermediate layer height can be assigned to representative orientation where that angle is between 57° and 78° and the largest layer height can be assigned to orientations where that angle is between 0° and 57°.

At step 514, the method determines if there are more sampling planes to be processed in the band. If there are more sampling planes, the process returns to step 500 to select the next sampling plane above the current sampling plane in the band and steps 502-512 are repeated for the next sample.

When a best layer height has been identified for each sampling plane in the band at step 514, a limited-span voting method is used to identify a filtered layer height for each sampling plane at step 516. In the limited-span voting, each sampling plane in the band is selected in turn. For each sampling plane, the layer heights for a number of sampling planes, S, above and below the sampling planes are retrieved. In accordance with one embodiment, the number of sampling planes S is half the number of sampling planes in the band. The layer height that is found most often in this limited span of sampling planes is then assigned as the filtered layer height for the selected sampling plane. If there are fewer than S sampling planes above or below the selected sampling plane, only the existing sampling planes participate in the vote. The limited-span voting of step 516 is not performed in all embodiments.

At step 518, a voting method is used to select the best layer height for the band. In particular, for each layer height, the number of sampling planes that were assigned that layer height at step 516 (or step 512 if step 516 is not performed) is determined and the layer height assigned to the largest number of sampling planes is selected as the best layer height for the band.

Returning to FIG. 2, after the best layer height for the band has been determined from the polygons of the model at step 208, a layer height for the band is set at step 210 using the identified best layer height, a current layer height for the layer directly below the band and the maximum allowed change in layer height set in layer height parameters 154. In particular, if the best layer height identified for the band differs from the current layer height by more than the maximum allowed change in layer height, a usable layer height that is between the current layer height and the identified best layer height is selected as the layer height for the band. The selected layer height will be the layer height between the current and best layer heights that is closest to the identified best layer height without differing from the current layer height by more than the maximum allowed change in layer heights. If the best layer height does not differ from the current layer height by more than the maximum allowed change in layer heights, the identified best layer height is set as the layer height for the band.

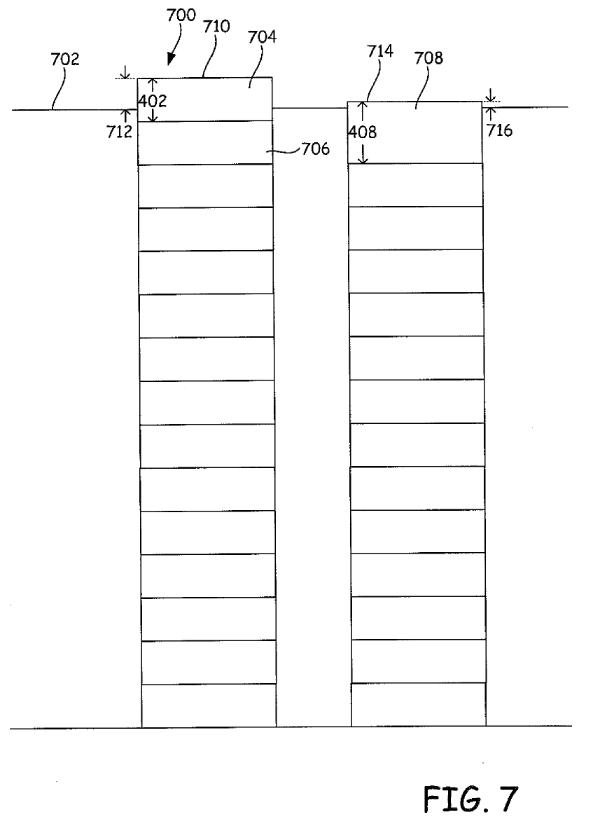

At step 212, the heights of one or more layers in the band are altered in order to better align a top of a layer with a key point in height key points 160. For example, in FIG. 7, column 700 shows layers, such as layers 704 and 706, for a band as determined at step 210. A height key point 702 is shown relative to the top of the band. As shown in FIG. 7, the selection of height 402 for the layers in the band will cause the top 710 of last layer 704 to be above height key point 702 by a distance 712. In step 212, top layer 704 is removed and layer 706 is replaced with a layer 708 having taller height 408 such that a top 714 of layer 708 is a shorter distance 716 from height key point 702.

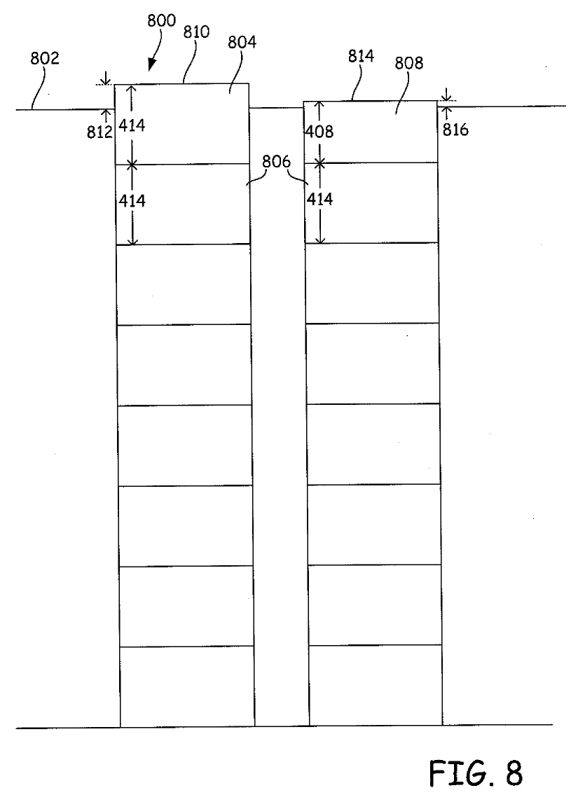

In a second example shown in FIG. 8, column 800 shows layers, such as layers 804 and 806, for a band as determined at step 210. A height key point 802 is shown relative to the top of the band. As shown in FIG. 8, the selection of height 414 for the layers in the band will cause the top 810 of last layer 804 to be above height key point 802 by a distance 812. In step 212, top layer 804 is replaced with a layer 808 having shorter height 408 such that a top 814 of layer 808 is a shorter distance 816 from height key point 802.

After the height of one or more layers have been adjusted at step 212, the process of FIG. 2 continues at step 214 where the portion of the model within the current band is sliced using the selected layer height(s) to form tool paths with layer heights 152 for the band.

At step 216, the process determines if the top of the model has been reached. If the top of the model has not been reached, the process continues at step 218 where the best layer height for the next layer is determined. In accordance with one embodiment, the best layer height for the next layer is determined using the process of FIG. 5 while using the height of the current layer as the band height. At step 220, if the best layer height for the next layer is the same as the current layer height, the next layer of the model is sliced at step 222 using the current layer height. Thus, the current layer height will continue to be used to slice the model as long as the current layer height is the best layer height for the next layer. If the current layer height is not the best layer height at step 220, the process returns to step 206 to select the next band of the model and steps 208-216 are repeated for the new band.

When the top of the model is reached at step 216, the process ends at step 224.

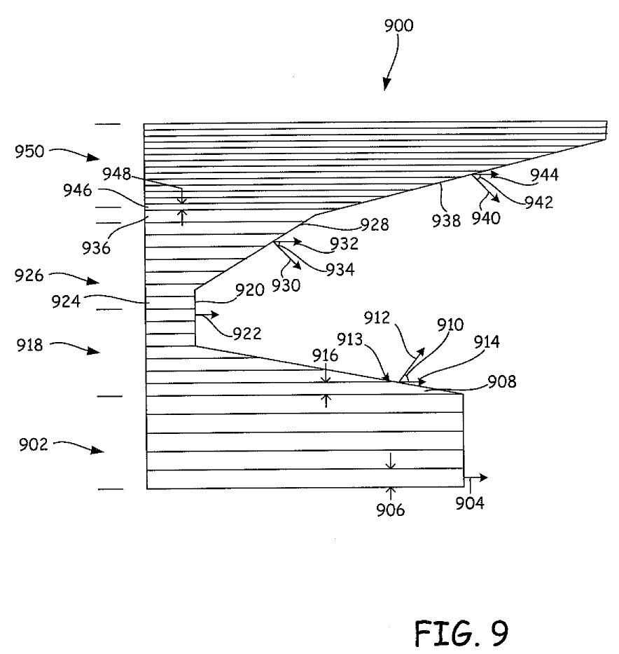

FIG. 9 shows the results of the process of FIG. 2 for a model 900. In FIG. 9 a side view of model 900 is shown. In the discussion below, only the surfaces along the right side are discussed to simplify the description. However, as discussed above, for each sample, all of the surfaces intersected by the sample are considered when identifying the best layer height.

The first band selected by step 206 of the process of FIG. 2 is band 902. Across this band, the angle between the outwardly facing normal 904 and the horizontal component of the normal is zero degrees. As a result, the best layer height for band 902 is the largest available layer height 906. After band 902 has been sliced using layer height 906, the best layer height for layer 908 is determined at step 218. Since the angle 910 between normal 912 of surface 913 and the horizontal component 914 of normal 912 is in an upper range, a smallest layer height is identified as the best layer height for layer 908. Since this layer height is different from the layer height of band 902, the method of FIG. 2 returns to step 206 and selects band 918 as the next band to process.

Band 918 spans two surfaces 913 and 920, which have different normals 912 and 922. The angle between normal 912 and horizontal component 914 of normal 912 is in the upper range while the angle between normal 922 and its horizontal component is zero degrees. Based on the voting performed by the different sampling planes across the band, the shortest layer height is identified as the best layer height for band 918 at step 208. However, since the top layer of band 902 is the largest layer height and the difference between the largest layer height and the smallest layer height exceeds the maximum allowed change in layer heights, the layer height for band 918 is set to the intermediate layer height 916 at step 210.

After the layer height has been selected for band 918, the process of FIG. 2 determines the best layer height for layer 924 at step 218. Because normal 922 of surface 920 is at zero degrees to the horizontal component of normal 922, the best layer height is the largest layer height. Since this is different from the layer height of the top layer of band 918, the process returns to step 206 where it selects band 926. The process then determines the best layer height for band 926 at step 208. Band 926 includes surface 920 and an angled surface 928, where angled surface 928 has a normal 930 that is at an angle 934 to the horizontal component 932 of normal 930. Angle 934 is in an intermediate range of angles and as such, intermediate layer height 916 is identified as the best layer height for band 926 at step 208. Since this is the same as the top layer of band 918, the best layer height for band 926 is selected as the band layer height at step 210.

At step 216, the process of FIG. 2 determines that the top of the model has not been reached and at step 218, the process determines the best layer height for the next layer 936, which includes surface 928 and surface 938. Normal 930 of surface 928 is at an intermediate angle to horizontal component 932 while normal 940 of surface 938 is at a large angle 942 to the horizontal component 944 of normal 940. As a result, different sample planes within layer 936 will have different best layer heights. Using the voting of step 518 of FIG. 5, layer height 916 is selected as the best layer height for layer 936.

The process then returns to step 216 where the process determines that the top of the model has not been reached and the best layer height for a next layer 946 is determined at step 218. For layer 946, the best layer height is a small layer height 948. Since this layer height is different from the layer height of layer 936, the process returns to step 206 to select band 950, which includes layer 946. The best layer height for band 950 is then identified at step 208 as small layer height 948. Since small layer height 948 differs from layer height 916 of layer 936 by less than the maximum allowed change in layer heights, small layer height 948 is selected as the layer height for band 950 at step 212.

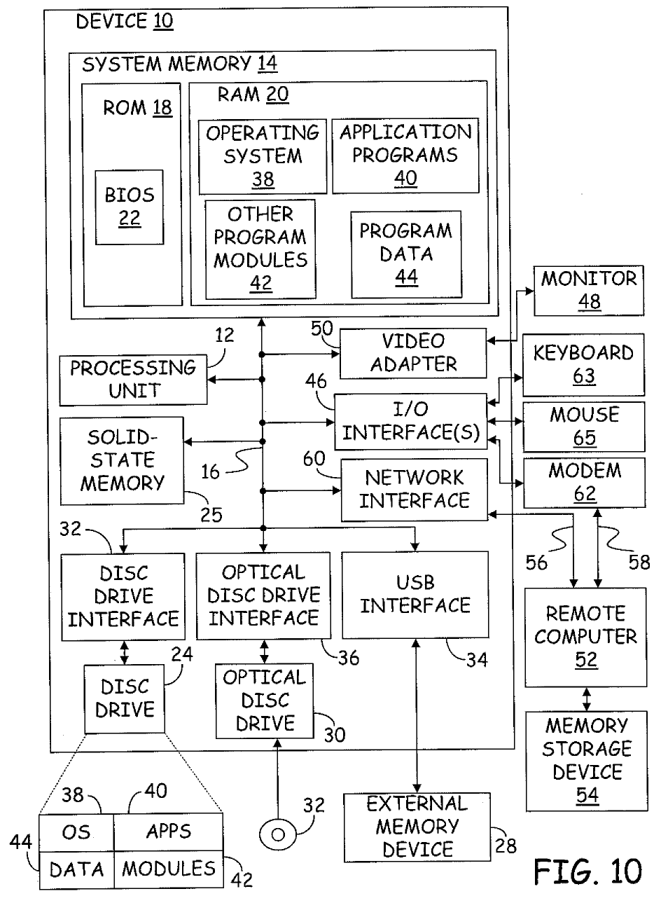

FIG. 10 provides an example of a computing device 10 that can be used as computing device 150 or as part of controller assembly 138. Computing device 10 includes a processing unit 12, a system memory 14 and a system bus 16 that couples the system memory 14 to the processing unit 12. System memory 14 includes read only memory (ROM) 18 and random access memory (RAM) 20. A basic input/output system 22 (BIOS), containing the basic routines that help to transfer information between elements within the computing device 10, is stored in ROM 18. Computer-executable instructions that are to be executed by processing unit 12 may be stored in random access memory 20 before being executed.

Embodiments of the present invention can be applied in the context of computer systems other than computing device 10. Other appropriate computer systems include handheld devices, multi-processor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present invention may be accomplished utilizing either local or remote storage devices, or simultaneously utilizing both local and remote storage devices.

Computing device 10 further includes an optional hard disc drive 24, an optional external memory device 28, and an optional optical disc drive 30. External memory device 28 can include an external disc drive or solid state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives and external memory devices and their associated computer-readable media provide nonvolatile storage media for the computing device 10 on which computer-executable instructions and computer-readable data structures may be stored. Other types of media that are readable by a computer may also be used in the exemplary operation environment.

A number of program modules may be stored in the drives and RAM 20, including an operating system 38, one or more application programs 40, other program modules 42 and program data 44. In particular, application programs 40 can include programs for implementing slicing module 156, for example. Program data 44 may include data such as data in layer height parameters 154, 3-D model 158, height key points 160 and toolpaths with layer heights 152, for example.

Processing unit 12, also referred to as a processor, executes programs in system memory 14 and solid state memory 25 to perform the methods described above.

Input devices including a keyboard 63 and a mouse 65 are optionally connected to system bus 16 through an Input/Output interface 46 that is coupled to system bus 16. Monitor or display 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

The computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 10. The network connections depicted in FIG. 10 include a local area network (LAN) 56 and a wide area network (WAN) 58. Such network environments are commonplace in the art.

The computing device 10 is connected to the LAN 56 through a network interface 60. The computing device 10 is also connected to WAN 58 and includes a modem 62 for establishing communications over the WAN 58. The modem 62, which may be internal or external, is connected to the system bus 16 via the I/O interface 46.

In a networked environment, program modules depicted relative to the computing device 10, or portions thereof, may be stored in the remote memory storage device 54. For example, application programs may be stored utilizing memory storage device 54. In addition, data associated with an application program may illustratively be stored within memory storage device 54. It will be appreciated that the network connections shown in FIG. 10 are exemplary and other means for establishing a communications link between the computers, such as a wireless interface communications link, may be used.

Suitable 3D printers or additive manufacturing systems for printing 3D parts according to the methods of the embodiments include any suitable additive manufacturing technology or 3D printing system that may benefit from the embodiments, such as those based on extrusion-based techniques, ink jetting, selective laser sintering, powder/binder jetting, electron-beam melting, digital light processing (DLP), stereolithography, direct laser metal sintering, electrophotographic and electrostatographic processes. Although the present invention has been described with reference to preferred embodiments, workers skilled in the art will recognize that changes may be made in form and detail without departing from the spirit and scope of the invention.

What is claimed is:

1. A method of additive manufacturing that prints a part by adding layers to the part, the method comprising:
determining an orientation of at least one surface of a model of the part; and
setting a layer height for a layer to be added to the part based on the determined orientation of the at least one surface of the model of the part.

2. The method of claim 1 wherein determining an orientation of at least one surface comprises determining an orientation of multiple surfaces intersected by a sampling plane.

3. The method of claim 2 wherein the setting a layer height for a layer comprises determining a representative orientation for the sampling plane based on the orientations of the multiple surfaces intersected by the sampling plane and using the representative orientation to set the layer height.

4. The method of claim 3 wherein sampling plane is one of a plurality of sampling planes and wherein for each sampling plane in the plurality:
orientations of multiple surfaces intersected by the sampling plane are determined; and
a representative orientation is determined for the sampling plane based on the orientations of the multiple surfaces intersected by the sampling plane.

5. The method of claim 4 wherein setting a layer height comprises identifying a best layer height for each sampling plane based on the sampling plane's representative orientation and setting the layer height based in part on the best layer heights of the sampling planes.

6. The method of claim 5 wherein the best layer height for a nearly horizontal representative orientation is shorter than the best layer height for a nearly vertical representative orientation so as to produce a part with less jagged nearly horizontal surfaces.

7. The method of claim 5 wherein setting the layer height based in part on the best layer heights of the sampling planes comprises selecting the layer height that was most often identified as the best layer height for the sampling planes.

8. The method of claim 5 wherein the plurality of sampling planes span a band height and wherein setting a layer height comprises setting a layer height for multiple layers within the band height.

9. The method of claim 1 wherein setting a layer height further comprises setting the layer height based on a layer height of a previous layer and a limitation on how much layer heights can change between layers.

10. The method of claim 1 wherein setting the layer height comprises selecting the layer height from a set of discrete layer heights.

11. The method of claim 1 wherein each of the discrete layer heights is an integer multiple of a vertical interval between the sampling planes.

12. The method of claim 1 further comprising setting the layer height based in part on a desired position for the top of the layer.

13. The method of claim 1 further comprising printing a part using the layer height set for the layer.

14. A method comprising:
receiving a model of a part and designating different layer heights for different portions of the part based in part on orientations of surfaces of the model.

15. The method of claim 14 wherein designating different layer heights for different portions of the part further comprises designating the different layer heights based in part on a minimum band height over which the layer height is required to be constant.

16. The method of claim 15 wherein designating different layer heights for different portions of the part further comprises designating the different layer heights based in part on a maximum allowed change in layer heights between successive layers.

17. The method of claim 16 wherein designating different layer heights for different portions of the part based in part on orientations of surfaces of the model comprises:
sampling the model using a plurality of sampling planes such that for each sampling plane, the orientations of the surfaces that intersect the sampling plane are determined and a representative surface orientation is determined from the surfaces' orientations; and
using the representative surface orientations of the sampling plane to designate a layer height.

18. The method of claim 17 wherein using the representative surface orientations of the sampling plane to designate a layer height comprises selecting a best layer height for each sampling plane based on the respective representative surface orientation of the sampling plane and designating the layer height as the layer height selected for the most sampling planes.

19. The method of claim 14 further comprising printing a part using the designated layer heights.

20. A method comprising:
receiving a model of a part; and
slicing the part to form tool paths with layer heights wherein different tool paths have different layer heights based in part on orientations of surfaces of the model.

21. The method of claim 20 further comprising determining a layer height for a tool path through steps comprising:
for each of a plurality of sampling planes along the model, determining the orientations of surfaces at the sampling plane, determining a representative orientation from the surface orientations, and selecting a best layer height for the sampling plane based on the representative orientation; and
using the best layer height for each sampling plane to select the layer height for the tool path.

22. The method of claim 21 wherein using the best layer height for each sampling plane comprises selecting the layer height that was selected as the best layer height by a largest number of the plurality of sampling planes as the layer height for the tool path.

23. The method of claim 22 wherein the plurality of sampling planes together span multiple tool path layers.

24. The method of claim 20 further comprising printing the part using the different layer heights.

25. A method comprising:
printing a near net part by depositing successive layers to form the near net part, at least one of the successive layers having a different layer height than others of the successive layers and wherein one of the layer heights is selected based in part on a desired position for the top of a layer.
